(19) United States
(12) Patent Application Publication
(10) Pub. No.: US 2002/0136494 A1
(43) Pub. Date: Sep. 26, 2002

(54) Optical device

(76) Inventors: Tomonori Yazaki, Kamifukuoka-shi (JP); Masayoshi Horita, Kamifukuoka-shi (JP); Shinsuke Tanaka, Kamifukuoka-shi (JP); Yuichi Matsushima, Kamifukuoka-shi (JP)

Correspondence Address: CHRISTIE, PARKER & HALE, LLP, 350 WEST COLORADO BOULEVARD, SUITE 500, PASADENA, CA, 91105, US

(21) Appl. No.: 10/104,505

(22) Filed: Mar. 21, 2002

(30) Foreign Application Priority Data
Mar. 22, 2001 (JP) 2001-082290

(51) Int. Cl. G02B 6/34; G02B 6/26

(52) U.S. Cl. 385/37; 385/50

(57) ABSTRACT

An object of this invention is to improve wavelength selectivity. Two optical waveguides (10 and 12) are disposed side by side on surfaces at different heights from each other, and a diffraction grating (14) is disposed between them. The two optical waveguides (10 and 12) cross at an angel θ in an area (16) where they mutually approach. Here, θ is not zero, and preferably should be approximately 0.5°.

### FIELD OF THE INVENTION

This invention relates to an optical device, and more specifically to an optical device applicable to a transmission optical filter, reflection optical filter, and optical add/drop multiplexer.

### BACKGROUND OF THE INVENTION

As a configuration of optical add/drop multiplexers, the one in which two optical waveguides are closely disposed in parallel and a diffraction grating is disposed between them is well known (See, for example, U.S. Pat. No. 5,859,941). This waveguide type optical device is also applicable to a transmission optical filter and reflection optical filter.

However, when a conventional type is used as an optical add/drop multiplexer, it drops wavelength components other than an objective band because a side-lobe suppression ratio is not sufficiently high. That is, the wavelength selectivity is insufficient in the conventional configurations.

### SUMMARY OF THE INVENTION

It is therefore an object of the present invention to provide an optical device having improved wavelength selectivity.

This present invention consists of two optical waveguides disposed on surfaces at different heights from each other to cross mutually at an angle of non-zero taken in a normal direction of one of the surfaces and a diffraction grating disposed between the two optical waveguides to optically couple the two optical waveguides.

An optical device according to the invention consists of two optical waveguides disposed on surfaces at different heights from each other to change in such a manner that they mutually approach until a distance between their optical axes reaches a predetermined distance along their optical axis directions and after that reversely separate from each other and a diffraction grating disposed between the two optical waveguides to optically couple the two optical waveguides.

### BRIEF DESCRIPTION OF THE DRAWING

The above and other objects, features and advantages of the present invention will be apparent from the following detailed description of the preferred embodiments of the invention in conjunction with the accompanying drawings, in which:

FIG. 1 is a perspective view of an embodiment according to the invention;

FIG. 2 is a plan view of the embodiment;

FIG. 3 is a cross-sectional view taken on line A-A of FIG. 2;

FIG. 4 is an enlarged view of a crossed part;

FIG. 5 shows calculated examples of normalized optical intensity of transmission light and dropped light respect to cross angel θ; and

FIG. 6 shows calculated examples of side-lobe suppression ratio respect to the cross angel θ.

### DESCRIPTION OF THE PREFERRED EMBODIMENT

Embodiments of the invention are explained below in detail with reference to the drawings.

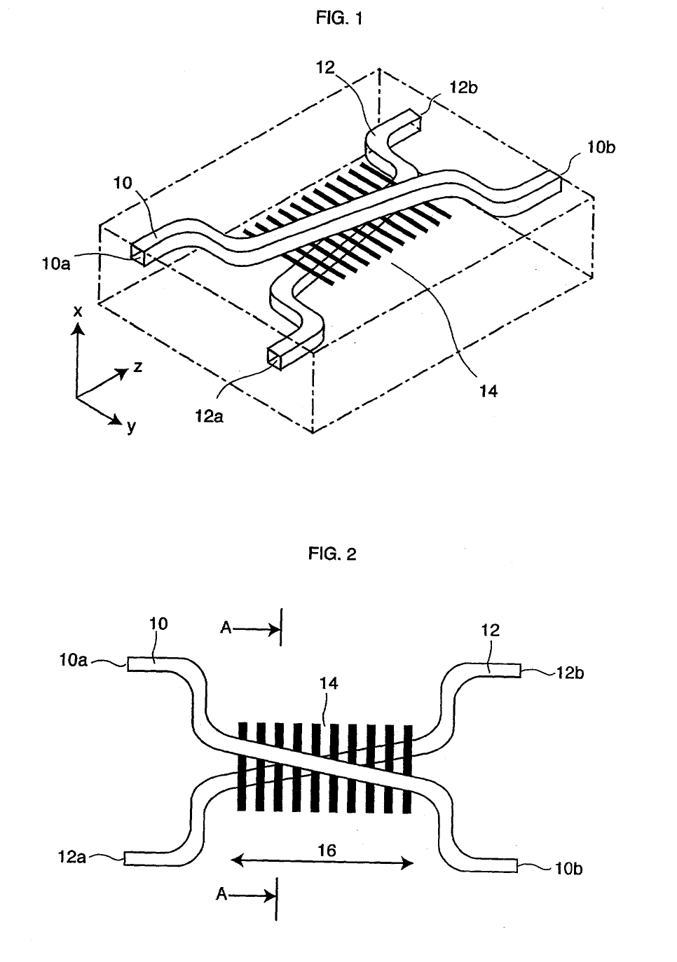

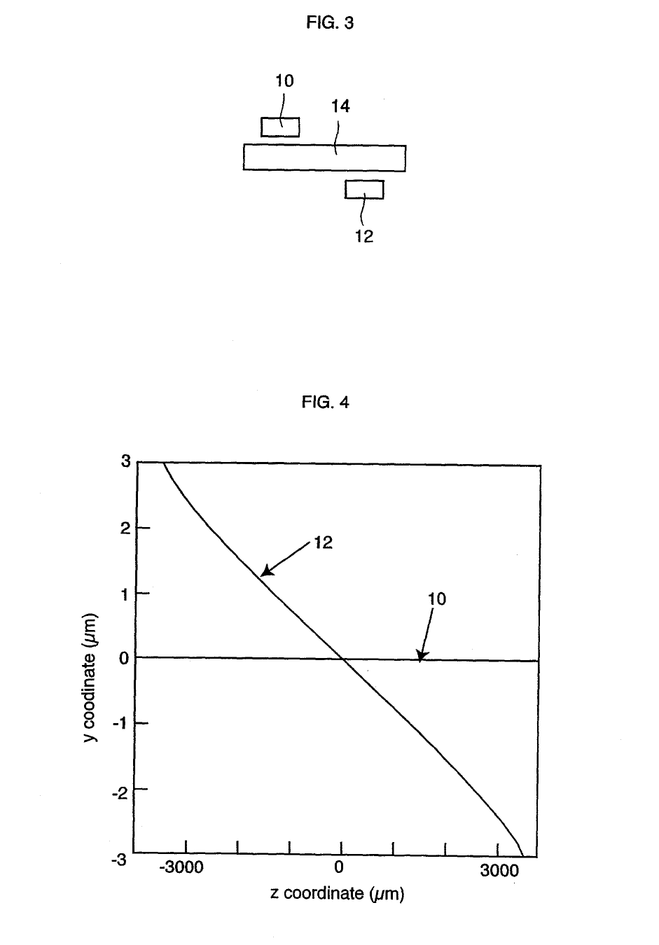

FIG. 1 illustrates a perspective view of an embodiment according to the invention, FIG. 2 shows a plan view of an optical waveguide configuration, and FIG. 3 depicts a cross-sectional view taken on line A-A of FIG. 2.

In the embodiment, two optical waveguides 10 and 12 are disposed side by side at different heights, and a diffraction grating 14 is disposed between them. The optical waveguides 10 and 12 cross at an angel θ in a mutually approaching area 16 (or an area wherein the optical waveguides 10 and 12 are optically coupled by the diffraction grating 14) as shown exaggeratedly in the plan view of FIG. 2. Although θ=0 in conventional configurations, θ≠0 in this embodiment. FIG. 4 is an enlarged view of an example of the cross part of the optical waveguides 10 and 12.

In the area 16, each of the optical waveguides 10 and 12 can be either a straight line or a curved line. However, when the optical waveguides 10 and 12 are both straight lines in the area 16, preferably the cross angel θ between the optical waveguides 10 and 12 should be off to the side about 1˜5 μm at the end of the area 16. The preferable cross angel θ will be described later.

According to the optical waveguides 10 and 12, diffraction grating 14, and their intervals, it is possible to control optical couplings of same direction and reverse direction. One ends of the optical waveguides 10 and 12 on the same side are expressed 10a and 12a respectively, and the other ends are expressed 10b and 12b respectively. In this embodiment, three kinds of optical paths can be set and selected respect to the light entered the end 10a of the optical waveguide 10. A first optical path has a configuration in which the light entered the end 10a of the optical waveguide 10 propagates on the optical waveguide 10 and outputs from the other end 10b of the optical waveguide 10. A second optical path has a configuration in which the light entered the end 10a of the optical waveguide 10 couples with the optical waveguide 12 in the same direction and outputs from the end 12b of the waveguide 12. A third optical path has a configuration in which the light entered the end 10a of the optical waveguide 10 couples with the optical waveguide 12 in the opposite direction and outputs from the end 12a of the optical waveguide 12.

In the example shown in FIG. 2, a wavelength λ1 propagates on the first optical path, a wavelength λ2 propagates on the second optical path, and a wavelength λ3 propagates on the third optical path. It is possible to set and select the wavelengths λ1, λ2, and λ3 by adjusting a pitch of the diffraction grating 14 according to a purpose.

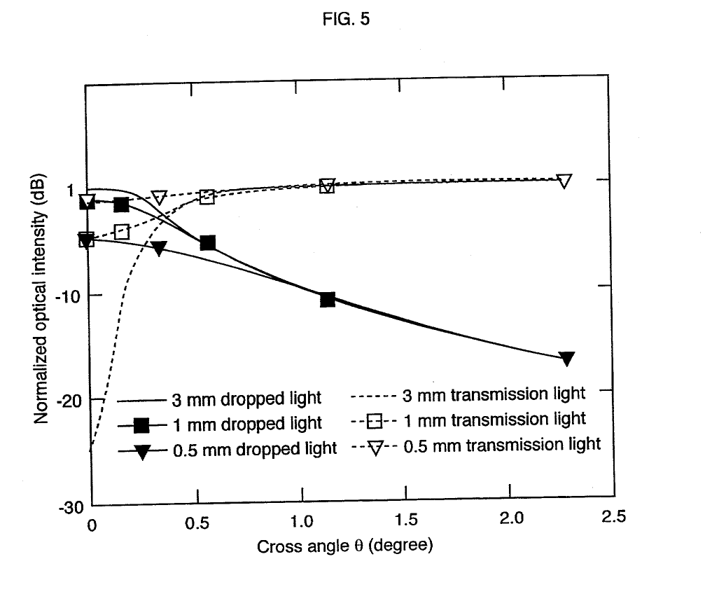

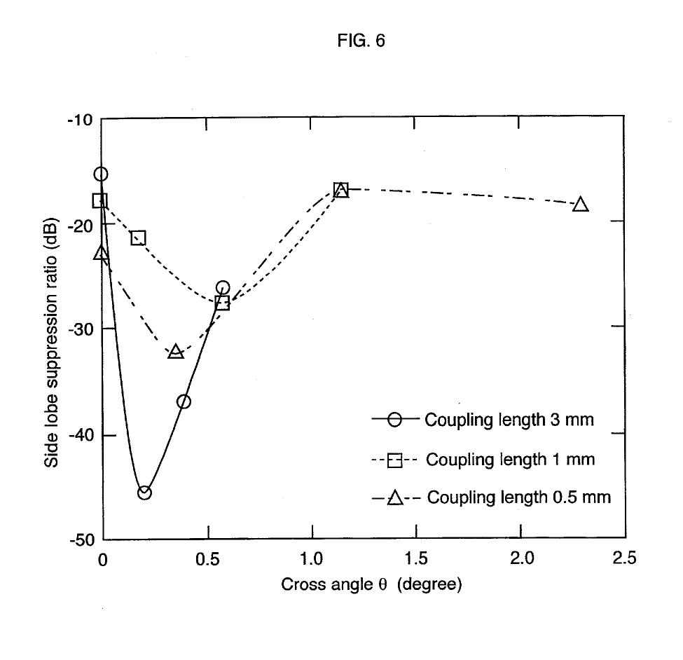

The transmission characteristics, drop characteristics, and side-lobe suppression characteristics respect to the cross angle θ are studied. FIG. 5 shows a calculated example of normalized optical intensity of transmission light and dropped light respect to the cross angel θ, and FIG. 6 shows a calculated example of a side-lope suppression ratio of a wavelength approximately 0.8 nm apart from a center wavelength. In FIG. 5, the horizontal axis depicts the cross angel θ, and the vertical axis depicts the normalized optical intensity (dB). In FIG. 6, the horizontal axis depicts the cross angel θ, and the vertical axis depicts the side-lobe suppression ratio (dB). Specifically, the transmission characteristics, drop characteristics, and side-lobe suppression characteristics are studied in cases that a coupling length, namely the length of the area 16, is 0.5 mm, 1 mm, and 3 mm.

Assuming that the optical waveguides are used as an add/drop multiplexing element, the transmission characteristics shown as a broken line become better as the normalized optical intensity becomes smaller than 1, and drop characteristics shown as a solid line become better as the normalized optical intensity approaches 1. From this point of view, it is preferable that, within the studied range, the cross angel θ is 0.5° or less, ideally 0°.

However, if the side-lobe suppression ratio which indicates the wavelength selectivity is considered, as obviously from FIG. 6, it is preferable to set the cross angle to approximately 0.5° rather than 0°. The optimum angle is approximately 0.2° when the coupling length is 3 mm, approximately 0.6° when the coupling length is 1 mm, and approximately 0.4° when the coupling length is 0.5 mm. Generally, the side-lobe suppression ratio required for a wavelength filter is −20 dB or less and accordingly the range of the cross angel θ should be between 0° and 1°.

When the optical waveguide 10 or 12 is a curve, it is preferable to curve gently around the area 16. It is because a steep change becomes one of reasons to cause a side-lobe.

Also, if one or both of the optical waveguides 10 and 12 are a curve, it is preferable to curve according to a function in which the coupling coefficient between the optical waveguides 10 and 12 becomes a Gaussian distribution respect to the signal propagation direction (the propagation direction of signal light on the optical waveguide 10, the propagation direction of signal light on the optical waveguide 12, or combined direction of the those two directions). The reason is because, compared to a straight cross optical waveguide having the same coupling length, it has almost the same side lobe suppression ratio and is still more efficient to reduce a normalized optical intensity of transmission light at a center wavelength of the filter and to increase a normalized optical intensity of dropped light.

The optical waveguides 10 and 12 can consist of either a semiconductor or a silica glass, and their waveguide configurations can be any one of a buried type, ridged type, ribbed type, and optical fiber. The shape of the cross section of the optical waveguides 10 and 12 can be either a circle or a rectangle.

As readily understandable from the aforementioned explanation, according to the invention, an optical device having an excellent wavelength selectivity to be used as an optical filter and add/drop multiplexing element etc. can be realized.

While the invention has been described with reference to the specific embodiment, it will be apparent to those skilled in the art that various changes and modifications can be made to the specific embodiment without departing from the spirit and scope of the invention as defined in the claims.

1. An optical device comprising:
two optical waveguides disposed on surfaces at different heights from each other to cross mutually at an angle of non-zero taken in a normal direction of one of the surfaces; and
a diffraction grating disposed between the two optical waveguides to optically couple the two optical waveguides.

2. The optical device of claim 1 wherein the cross angle of the two optical waveguides is greater than 0° and less than and equal to 1°.

3. An optical device comprising:
two optical waveguides disposed on surfaces at different heights from each other to change in such a manner that they mutually approach until a distance between their optical axes reaches a predetermined distance and after that reversely separate from each other along their optical axis directions; and
a diffraction grating disposed between the optical waveguides to optically couple the two optical waveguides.
